(19) United States
(12) Patent Application Publication
(10) Pub. No.: US 2005/0228716 A1
(43) Pub. Date: Oct. 13, 2005

(54) Methods and apparatuses for displaying promotions

(76) Inventors: Sean Christopher Endler, San Francisco, CA (US); Joseph Steven Herres, Seattle, WA (US); Ippei Tambata, San Francisco, CA (US)

Correspondence Address: Valley Oak Law, 5655 Silver Creek Valley Road, #106, San Jose, CA, 95138, US

(21) Appl. No.: 10/820,832

(22) Filed: Apr. 7, 2004

(51) Int. Cl. G06F 17/60; H04N 7/14

(52) U.S. Cl. 705/14

(57) ABSTRACT

In one embodiment, the methods and apparatuses detect a device; search for a plurality of promotions; detect a profile corresponding to the device wherein the profile contains a parameter; and select a particular promotion from the plurality of promotions based on the parameter associated with the profile.

### FIELD OF THE INVENTION

The present invention relates generally to displaying promotions and, more particularly, to displaying promotions based on a location of a participant.

### BACKGROUND

There has been a proliferation of portable electronic device utilized by both business and personal users. These portable electronic devices aid the user in tracking of their schedules, communicating with others via voice, and communicating with others via electronic messages. These portable electronic devices include cellular phones, personal digital assistants (PDAs), and the like.

For some users, these portable electronic devices are indispensable for organizing their calendars and communicating with others both for their professional and personal lives. For example, in some instances, the portable electronic device is used to set up a meeting between another person by communicating via either voice signals or electronic messages. In some instances, the portable electronic device is also used to store the meeting time and location on the user's calendar. In some instances, the portable electronic device also reminds the user of the scheduled meeting and directs the user to the meeting location based on the user's current location.

### SUMMARY

In one embodiment, the methods and apparatuses detect a device; search for a plurality of promotions; detect a profile corresponding to the device wherein the profile contains a parameter; and select a particular promotion from the plurality of promotions based on the parameter associated with the profile.

### BRIEF DESCRIPTION OF THE DRAWINGS

The accompanying drawings, which are incorporated in and constitute a part of this specification, illustrate and explain one embodiment of the methods and apparatuses for displaying promotions. In the drawings,

FIG. 1 is a diagram illustrating an environment within which the methods and apparatuses for displaying promotions are implemented;

FIG. 2 is a simplified block diagram illustrating one embodiment in which the methods and apparatuses for displaying promotions are implemented;

FIG. 3 is a simplified block diagram illustrating a system, consistent with one embodiment of the methods and apparatuses displaying promotions;

FIG. 4 is an exemplary record for use with the methods and apparatuses for displaying promotions;

FIG. 5 is an exemplary record for use with the methods and apparatuses for displaying promotions;

FIG. 6 is a flow diagram consistent with one embodiment of the methods and apparatuses for displaying promotions;

FIG. 7 is a flow diagram consistent with one embodiment of the methods and apparatuses for displaying promotions; and

FIG. 8 is an exemplary screen shot consistent with one embodiment of the methods and apparatuses for displaying promotions.

### DETAILED DESCRIPTION

The following detailed description of the methods and apparatuses for displaying promotions refers to the accompanying drawings. The detailed description is not intended to limit the methods and apparatuses for displaying promotions. Instead, the scope of the methods and apparatuses for displaying promotions are defined by the appended claims and equivalents. Those skilled in the art will recognize that many other implementations are possible, consistent with the present invention.

References to “device” include a device utilized by a user such as a computer, a portable computer, a personal digital assistant, a cellular telephone, and a device capable of receiving/transmitting an electronic message.

References to “promotion” include an advertisement for a product or service such as an electronic flier, an electronic coupon, an electronic announcement, and an electronic message. Further, a promotion also includes discounts, sales, and special offers for a particular product or service.

In one embodiment, the methods and apparatuses for displaying promotions select a particular promotion to display on a device corresponding to a user. In one embodiment, the particular promotion chosen to be displayed on the device is based on a variety of attributes within the device profile information and the promotion profile information. In one embodiment, the device profile information includes preferences for products/services and geographical boundaries. In one embodiment, the promotion profile information includes geographical location of the service/product provider, type of product/services offered, and valid hours of availability.

In another embodiment, the particular promotion is selected based on a meeting among multiple users. For example, the particular promotion is based on the location of the meeting in one embodiment. In another example, the particular promotion is based on the time of the meeting.

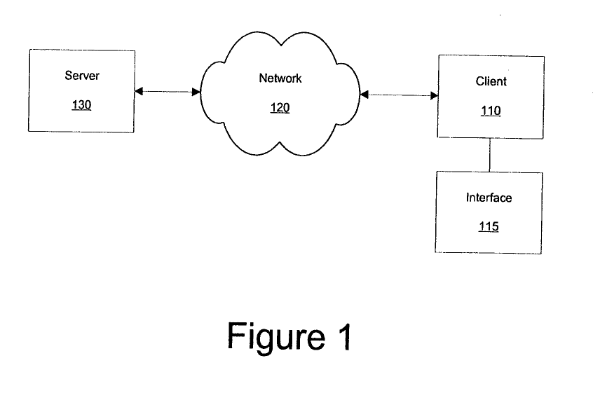

FIG. 1 is a diagram illustrating an environment within which the methods and apparatuses for displaying promotions are implemented. The environment includes an electronic device 110 (e.g., a computing platform configured to act as a client device, such as a computer, a personal digital assistant, and the like), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing such as a personal digital assistant. In other embodiments, one or more user interface 115 components (e.g., a keyboard, a pointing device such as a mouse, a trackball, etc.), a microphone, a speaker, a display, a camera are physically separate from, and are conventionally coupled to, electronic device 110. In one embodiment, the user utilizes interface 115 to access and control content and applications stored in electronic device 110, server 130, or a remote storage device (not shown) coupled via network 120.

In accordance with the invention, embodiments of displaying promotions below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

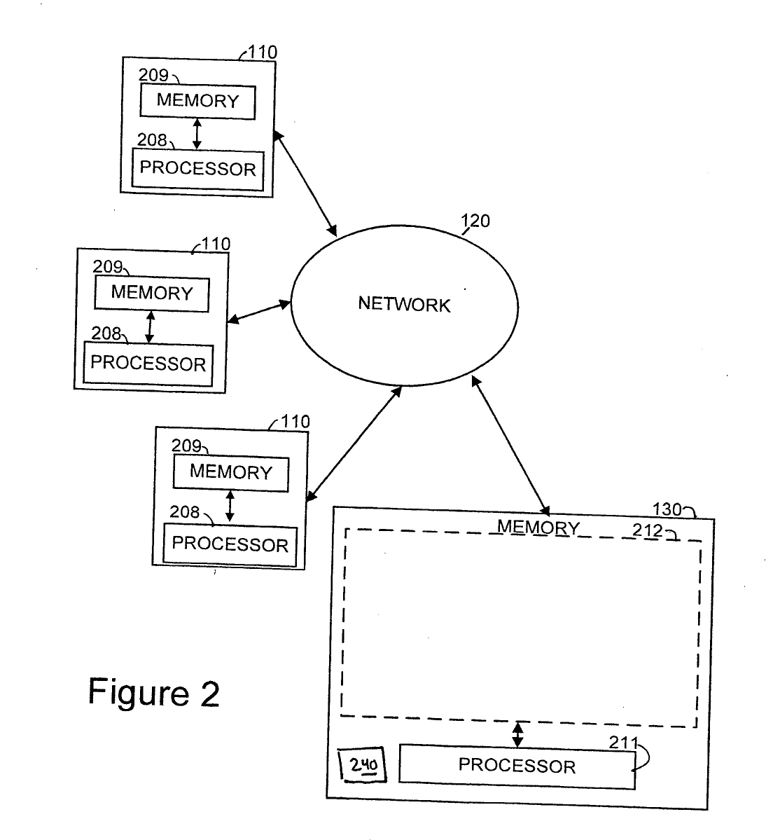

FIG. 2 is a simplified diagram illustrating an exemplary architecture in which the methods and apparatuses for displaying promotions are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. In one embodiment, a unique user operates each electronic device 110 via an interface 115 as described with reference to FIG. 1.

The server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

In one embodiment, the plurality of client devices 110 and the server 130 include instructions for a customized application for displaying promotions. In one embodiment, the plurality of computer-readable media 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in media 209, in media 212, or a single user application is stored in part in one media 209 and in part in media 212. In one instance, a stored user application, regardless of storage location, is made customizable based on displaying promotions as determined using embodiments described below.

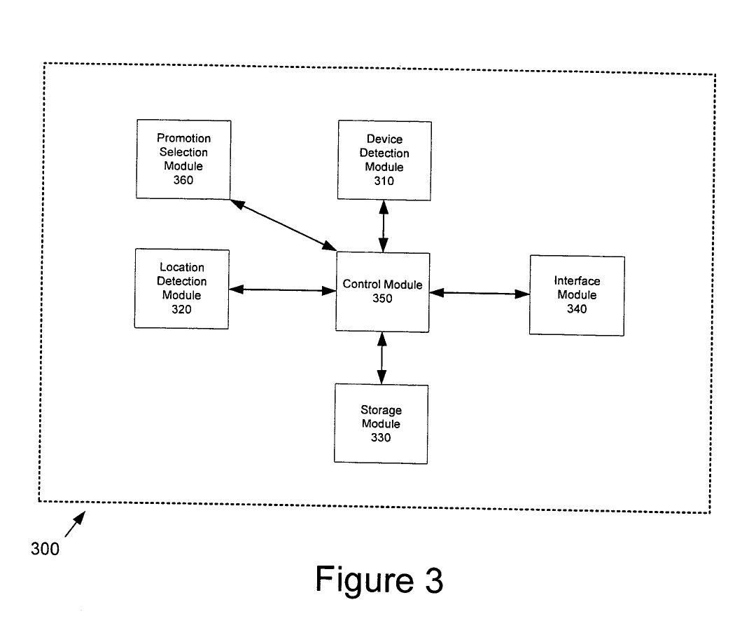

FIG. 3 illustrates one embodiment of a system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes a device detection module 310, a location detection module 320, a storage module 330, an interface module 340, a control module 350, and a promotion selection module 360.

In one embodiment, the control module 350 communicates with the device detection module 310, the location detection module 320, the storage module 330, the interface module 340, and the promotion selection module 360. In one embodiment, the control module 350 coordinates tasks, requests, and communications between the device detection module 310, the location detection module 320, the storage module 330, the interface module 340, and the promotion selection module 360.

In one embodiment, the device detection module 310 detects the identity the device. For example, each device is identified by a unique identifier such as a serial number. By uniquely identifying the device, a user corresponding to the specific device is also identified in one embodiment. For example, in the case where a unique user is registered with each unique device, the user is identified when the device is identified. In another example, where multiple users are associated with each unique device, a password is utilized to identify the current user of the device.

In one embodiment, the device detection module 310 receives a signal from the detected device. In one embodiment, the signal includes a serial number that identifies the particular device. In another embodiment, the signal includes a password that uniquely identifies the device and the user of the device.

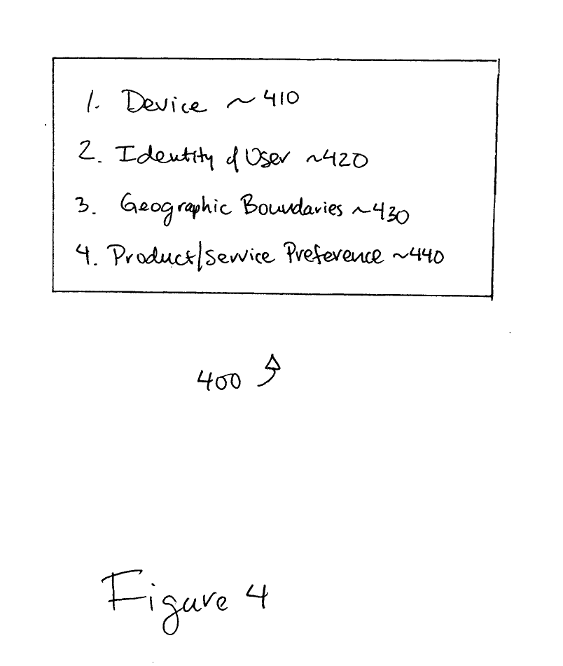

In one embodiment, by identifying the device and/or the user of the device, the device detection module 310 utilizes additional information associated with the particular device and/or user. Additional information corresponding with the particular device and/or user is shown in an exemplary record illustrated in FIG. 4. In one embodiment, this additional information is utilized by the system 300.

In one embodiment, the location detection module 320 determines the location of the device as detected in the Block 310. In one embodiment, the location detection module 320 utilizes a global positional system (GPS) via multiple satellites to identify the location of the device. In another embodiment, the location detection module 320 utilizes a cellular network to identify the location of the device. In yet another embodiment, the location detection module 320 utilizes at least one local sensor to detect the location of the device. In yet another embodiment, the location detection module 320 utilizes at least one other device to detect the location of the device. In yet another embodiment, the location detection module 320 utilizes the redemption location of the coupon to detect the location of the device.

In one embodiment, the location detection module 320 accurately detects the location of a device within one foot. In another embodiment, the location detection module 320 accurately detects the location of a device within a mile.

In one embodiment, the storage module 330 stores a record including information associated with a particular device. In another embodiment, the storage module 330 stores a record including information associated with a particular user. An exemplary embodiment of the information contained within the record associated with a user or device is illustrated in FIG. 4.

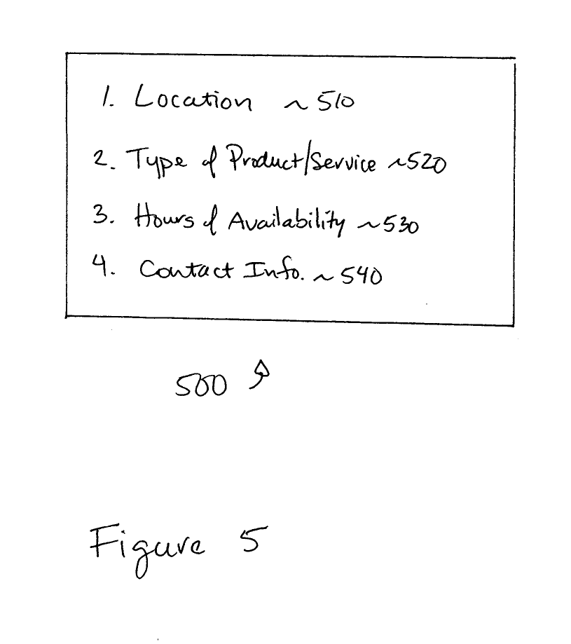

In another embodiment, the storage module 330 stores a record including information associated with a particular promotion or provider of the promotion. An exemplary embodiment of the information contained within the record associated with the promotion or provider of the promotion is illustrated in FIG. 5.

In one embodiment, the interface module 340 receives a signal from one of the electronic devices 110 indicating the identity of the device or user. In another embodiment, the interface module 340 receives a signal from one of the electronic devices 110 indicating the location of the device. In yet another embodiment, the interface module 340 transmits information to one of the electronic devices 110 indicating a possible promotion for use by the user of the electronic device 110.

In one embodiment, the promotion selection module 360 suggests a promotion for use by the user. In one embodiment, the promotion selection module 360 selects a promotion based on a meeting location chosen for users of the electronic devices 110. In another embodiment, the particular promotion is selected based on the location of at the electronic device 110 associated with the user. In another embodiment, the particular promotion is selected based on the location of least one of the devices 110 attending a meeting. In yet embodiment, the particular promotion is selected based on the time of day. In yet another embodiment, the particular promotion is selected based on the preferences of the users attending the meeting. In yet another embodiment, the particular promotion is selected based on the participation status of the user. For example, if the potential participant is “maybe” participating, a promotion is selected to specifically sway this participant to join the meeting.

The system 300 in FIG. 3 is shown for exemplary purposes and is merely one embodiment of the methods and apparatuses for displaying promotions. Additional modules may be added to the system 300 without departing from the scope of the methods and apparatuses for displaying promotions. Similarly, modules may be combined or deleted without departing from the scope of the methods and apparatuses for displaying promotions.

FIG. 4 illustrates an exemplary record 400 identifying attributes of a particular participant for use with the system 300. In one embodiment, there are multiple records such that each record 400 is associated with a particular participant. In one embodiment, the record 400 includes an identity of the device field 410, an identity of the user field 420, a geographic boundaries field 430, and a product/service preference field 440.

In one embodiment, the identity of the device field 410 uniquely identifies the device. In one example, a unique identification number is utilized to identify the particular device.

In one embodiment, the identity of the user field 420 uniquely identifies the participant. In one example, a password is utilized to identify the particular user.

In one embodiment, the same device is utilized by multiple participants. Accordingly, the identity of the user field 420 distinguishes between multiple participants utilizing the same device.

In another embodiment, each unique device is utilized by a single participant. In one example, the identity of the device is sufficient to identify the participant, and the identity of the user field 420 is not necessary. In another example, the identity of the user is sufficient to identify the participant, and the identity of the device field 410 is not necessary.

In one embodiment, the geographic boundaries field 430 identifies areas that are accessible to the particular participant. For example, if the particular participant associated with the record 400 is confined to traveling within the city limits, then the geographic boundaries field 430 describes this limitation. In one embodiment, the geographic boundary includes areas within the city of San Francisco. In another embodiment, the geographic boundary includes areas within California. In yet another embodiment, the geographic boundary includes areas within the United States. These geographic boundaries may be further refined and filtered based on different zoom magnifications of the display such as “city view”, “state view”, and “country view”.

In one embodiment, the geographic boundaries field 430 identifies areas that are accessible to the particular participant based on the current location of the participant. In this embodiment, the geographic boundary is relative to the current location of the participant. For example, the geographic boundary is any number of miles within the current location of the user.

In one embodiment, different geographic boundaries are established based on a particular time of day. For example, when traffic is heavy during rush hour, the geographic boundary is limited to locations within 2 miles of the current participant location. When traffic is lighter during non-rush hours, the geographic boundary is relaxed to locations within 20 miles of the current participant location. In addition to the time of day, the speed of movement is also tracked based on utilizing the last known position to determine the speed of movement.

In one embodiment, the product/service preference field 440 describes the types of service and products that are of interest to the particular user. In one embodiment, some users are interested in eating Japanese food while other users are interested in eating American food. In another embodiment, some users frequently purchase sporting goods, while other users frequently purchase home improvement supplies. The product/service preference field 440 allows the various interests and preferences of each user to be captured such as television viewing habits, frequency of movie ticket purchases, and the like.

FIG. 5 illustrates an exemplary record 500 identifying attributes of a particular promotion for use with the system 300. In one embodiment, there are multiple possible promotions such that each record 500 is associated with a particular promotion.

In one embodiment, the system 300 searches for promotions through the Internet and automatically saves theses promotions as records to be stored within the storage module 330. In this embodiment, the system 300 is able to set reasonable values for the various attributes for the records as shown below.

In an alternate embodiment, the system 300 accepts paid promotions from an advertiser as records to be stored within the storage module 330. In this embodiment, the advertisers are able to set their own values for the various attributes for the records as shown below.

In one embodiment, the record 500 includes an identity of the location field 510, a type of products or services field 520, a valid hours of availability field 530, and a contact information field 540.

In one embodiment, the identity of the location field 510 uniquely identifies the location of the particular promotion. In one example, a unique name is utilized to identify the identity of the particular promotion. Unique names include “Joe's Java”, “Bob's Burgers”, and “Golden Gate Park”.

In one embodiment, the type of products or services field 520 describes the type of products or services that are associated with the particular promotion. For example, under “Joe's Java”, the products listed include coffee, tea, limited food, restrooms, and indoor seating. In another example, under “Golden Gate Park”, the services listed include roller blade rental, picnic table rental, and food service.

In one embodiment, a particular product or service is listed as part of the promotion. For example, under “Joe's Java”, a promotion of purchase one coffee drink and get the second coffee drink for half price.

In one embodiment, the valid hours of availability field 530 describe the particular days and hours that the particular promotion is available. For example, under “Joe's Java”, the particular days and hours that the promotion offering a second coffee drink at half price are listed.

In one embodiment, the contact information field 540 describes contact information associated with the particular promotion. For example, the street address of the particular location for the promotion is listed. In another example, the phone number, email address, and web site for the particular location is also listed.

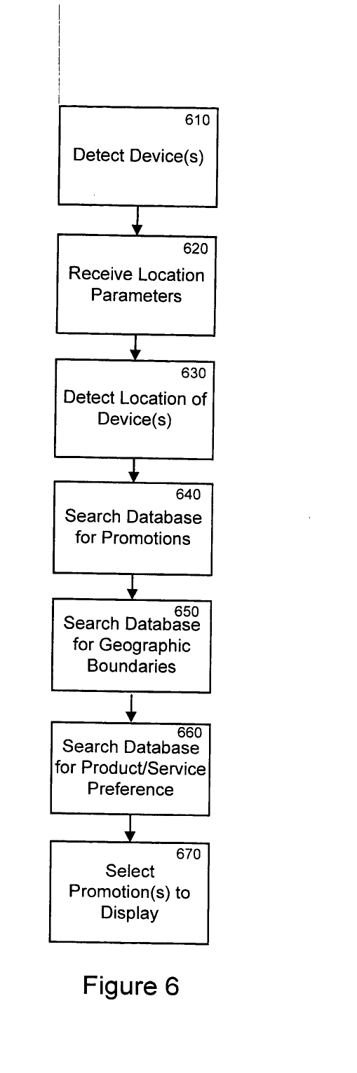

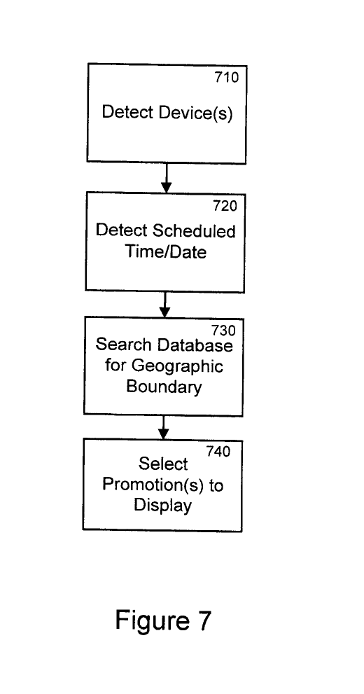

The flow diagrams as depicted in FIGS. 6 and 7 are one embodiment of the methods and apparatuses for displaying promotions. The blocks within the flow diagrams can be performed in a different sequence without departing from the spirit of the methods and apparatuses for displaying promotions. Further, blocks can be deleted, added, or combined without departing from the spirit of the methods and apparatuses for displaying promotions.

The flow diagram in FIG. 6 illustrates selecting a promotion based on multiple factors according to one embodiment of the invention.

In Block 610, selected devices are detected. In one embodiment, each device is associated with a different user. In another embodiment, multiple users are associated with the same device.

In one embodiment, the selected devices are attempting to set up a meeting among the users of the devices. In another embodiment, a single device is detected associated with a user that is attempting to schedule a time for purchasing a product or service. In yet another embodiment, a single device is detected that is associated with a user having various preferences that is a potential purchaser of a product or service.

In one embodiment, a meeting is defined as a gathering of more than one person for business or social activities. In one embodiment, the possible meeting participants are detected through their respective device within the device detection module 310. In another embodiment, the possible meeting participants are identified through their respective device within a database as represented by the exemplary record 400. In another embodiment, the possible meeting participants are detected by their proximity to each other and other physical locations such as a store for which a promotion is offered.

In Block 620, location parameters for a potential meeting or visit to purchase a product/service are received. In one embodiment, the parameters include the time and date of the meeting or visit to purchase a service/product, the duration of the meeting or visit to purchase a service/product, the type of amenities desired, and the general location of the meeting. In one embodiment, the type of amenities includes indoor seating, outdoor seating, type of food served, type of beverage served, cost range, activities available, and the like. In one embodiment, general geographic parameters are included. For example, possible meeting locations may be constrained to locations within San Francisco. In one embodiment, the parameters are received through the interface module 340.

In Block 630, the locations of the device(s) are detected. In one embodiment, the current locations of the device(s) are detected through GPS. In another embodiment, the locations of the device(s) are detected through a localized networks such as sensors, cellular network, Wi-Fi network, blue tooth network, and the like. In one embodiment, the current locations of the device(s) are detected through the location detection module 320.

In Block 640, a promotions database is searched for possible promotions. In one embodiment, the promotions database is housed within the storage module 330 and contains multiple records which each record identifies a possible promotion and includes attributes of the particular promotion. An exemplary record is shown in the record 500.

In one embodiment, a group of possible promotions are identified based on the parameters identified in the Block 620. For example, if the user predominantly drinks coffee drinks in cafes, then the promotions are limited to cafes in one embodiment. In an alternate embodiment, other advertisers in unrelated industries are capable of targeting specific demographics with their promotions. For example, if a car manufacturer wishes to target younger car buyers, then the car manufacturer is able to target promotions to younger users whom statistically consume coffee.

In Block 650, a user database is searched for geographic boundaries of the users detected within the Block 610. In one embodiment, the user database is housed within the storage module 330 and contains multiple records which each record identifies an individual user and the geographic boundaries specified by the user. An exemplary record is shown in the record 400.

In Block 660, a user database is searched for preferences for product or service for the users detected within the Block 610. In one embodiment, the user database is housed within the storage module 330 and contains multiple records which each record identifies an individual user and the various products or services specified by the user. An exemplary record is shown in the record 400.

In Block 670, one or more promotions are selected to be displayed to the users detected within the Block 610. In one embodiment, the selected promotions are displayed according to geographic vicinity to the user. For example, the promotions that are closer in geography to the user are listed first. In another embodiment, the selected promotions are displayed according to the expiration time and date of any coupons or discounts. For example, the promotions that are closer to expiration are listed first. In another embodiment, as the expiration time grows closer and within a predetermined amount of time, the promotion is highlighted on the device for the user. In one example, the promotion is highlighted by flashing the promotion on a display. In another example, the promotion is highlighted by providing an audio component that identifies the promotion.

In one embodiment, expiration of the promotion can be linked to the actions of the user. For example, a parking promotion for free parking for 2 hours expires if the user leaves a particular building or store.

In one embodiment, the promotions are selected based on the geographical boundaries of the users. For example, if the location corresponding to the promotion is too far away from the user, then that particular promotion is not displayed to the user. In an alternate embodiment, if the advertiser desires to have a corresponding promotion displayed regardless of the geographical boundaries of the users, then the geographical boundaries of the users are not utilized as a limiting factor.

In one embodiment, the promotions are selected based on the user's preferences for products or services. For example, if a user is interested in home improvement products, then promotions relating to home improvement products such as ladders, plumbing fixtures, and lumber would be displayed to the user. In another example, the user is interested in home improvement products, and promotions for products other than home improvement products such as cars wish to target users interested in home improvement products. In this example, these car promotions are displayed to the users even though the users may not be specifically interested in cars.

In one embodiment, multiple users schedule a meeting at a particular location. In one embodiment, selected promotions are displayed for the multiple users through their corresponding devices. These selected promotions are selected based on a variety of factors such as the location of the meeting, the time of the meeting, and type of products/services available at the location of the meeting.

In one embodiment, the selected promotions are chosen to complement the chosen meeting location and time. For example, if the meeting location is at particular fast food restaurant, then the selected promotions are related to or originate from the particular fast food restaurant. In another example, if the meeting time is determined, then the selected promotions are valid for the duration of the meeting time.

In an alternate embodiment, the selected promotions are chosen to differ from the chosen meeting location and time. For example, if the meeting location is at particular fast food restaurant, then the selected promotions are related to or originate from a competing fast food restaurant. In another example, if the meeting time is determined, then the selected promotions are valid for times that are different than the duration of the meeting time.

The flow diagram in FIG. 7 illustrates selecting a promotion based on multiple factors according to one embodiment of the invention.

In Block 710, selected devices are detected. In one embodiment, each device is associated with a different user. In another embodiment, multiple users are associated with the same device.

In Block 720, a time and date are scheduled for a meeting or shopping trip for at least one user.

In Block 730, a user database is searched for geographic boundaries of the users detected within the Block 710. In one embodiment, the user database is housed within the storage module 330 and contains multiple records which each record identifies an individual user and the geographic boundaries specified by the user. An exemplary record is shown in the record 400.

In Block 740, one or more promotions are selected to be displayed to the users detected within the Block 610. In one embodiment, the selected promotions are based on the time and date as detected in the Block 720. In one example, the selected promotions are limited to those that are valid during the time and date as detected in the Block 720. In another example, the selected promotions also include promotions that are within a predetermined amount of time before and after the time and date as detected in the Block 720.

In another embodiment, the selected promotions are based on the geographic boundaries as determined in the Block 730. For example, if the promotion is located outside the geographic boundaries, then the promotion is not selected to be displayed.

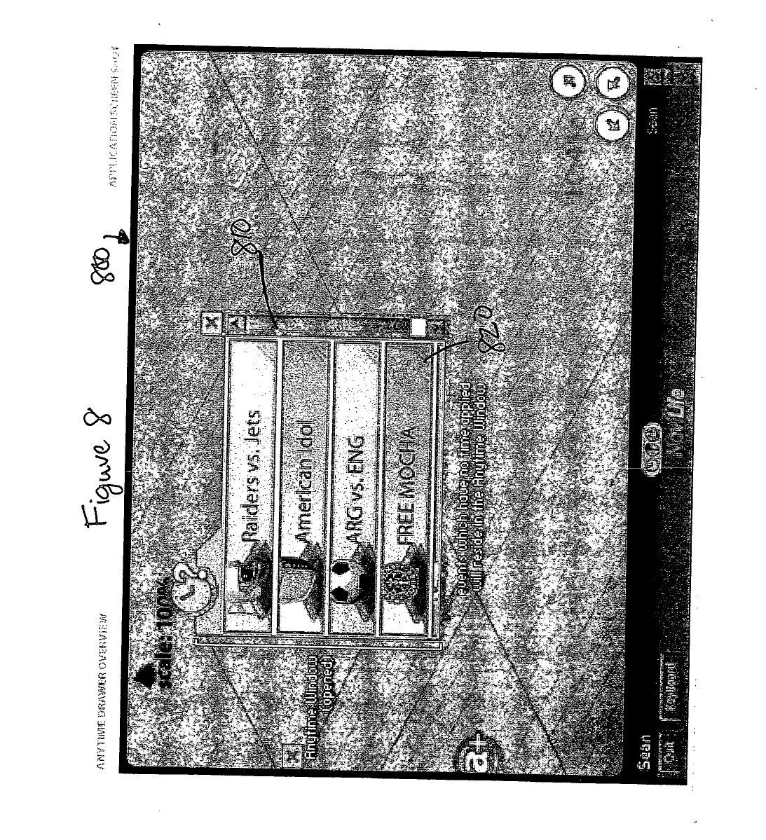

FIG. 8 illustrates a screen shot 800 that displays information relating to a promotion. In one embodiment, a promotion 820 is shown through a menu 810.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method comprising:
detecting a device;
searching for a plurality of promotions;
detecting a profile corresponding to the device wherein the profile contains a parameter; and
selecting a particular promotion from the plurality of promotions based on the parameter associated with the profile.

2. The method according to claim 1 further comprising detecting a location of the device.

3. The method according to claim 2 wherein selecting the particular promotions is based on the location of the device.

4. The method according to claim 1 wherein the parameter includes a preference for a product.

5. The method according to claim 1 wherein the parameter includes a preference for a service.

6. The method according to claim 1 wherein the parameter includes a geographic boundary.

7. The method according to claim 1 further comprising detecting a profile for each of the plurality of promotions.

8. The method according to claim 7 wherein the profile for each of the plurality of promotions includes location information.

9. The method according to claim 7 wherein the profile for each of the plurality of promotions includes a description of offerings.

10. The method according to claim 7 wherein the profile includes days and time of validity for each of the plurality of promotions.

11. The method according to claim 7 wherein selecting the particular promotion is based on profile for each of the plurality of promotions.

12. The method according to claim 1 further comprising displaying the particular promotion on the device.

13. The method according to claim 1 further comprising highlighting the particular promotion prior to an expiration of the particular promotion.

14. The method according to claim 1 wherein the device is associated with a particular user.

15. The method according to claim 1 wherein the device is associated with multiple users.

16. A system comprising:
means for detecting a device;
means for searching for a plurality of promotions;
means for detecting a profile corresponding to the device wherein the profile contains a parameter; and
means for selecting a particular promotion from the plurality of promotions based on the parameter associated with the profile.

18. A method comprising:
detecting a plurality of devices;
identifying a location for a meeting among the plurality of devices;
searching for a plurality of promotions; and
selecting a particular promotion from the plurality of promotions based on the location of the meeting.

19. The method according to claim 18 wherein selecting the particular promotion is based on a time of the meeting.

20. The method according to claim 18 wherein selecting the particular promotion further comprises matching the location with the particular promotion such that the particular promotion is utilized at the location.

21. The method according to claim 18 wherein selecting the particular promotion further comprises matching the location with the particular promotion such that the particular promotion is utilized at a competing location.

22. The method according to claim 18 wherein selecting the particular promotion further comprises matching the location with the particular promotion such that the particular promotion is utilized at another location unrelated to the location.

23. The method according to claim 18 further comprising detecting a current location for each of the plurality of devices.

24. A system, comprising:
a device detection module to detect a device associated with a user;
a storage module to store a device record containing user information associated with the user and a promotion record containing promotion information associated with a promotion; and
a promotion location selection module to select a particular promotion based on the user information and the promotion information.

25. The system according to claim 24 wherein the user information includes a user preference for a product.

26. The system according to claim 24 wherein the user information includes a user preference for a service.

27. The system according to claim 24 wherein the user information includes a geographic boundary.

28. The system according to claim 24 wherein the promotion information includes a time and data validity.

29. The system according to claim 24 wherein the promotion information includes location information.

30. A computer-readable medium having computer executable instructions for performing a method comprising:
detecting a plurality of devices;
identifying a location for a meeting among the plurality of devices;
searching for a plurality of promotions; and
selecting a particular promotion from the plurality of promotions based on the location of the meeting.
